(19) United States
(12) Patent Application Publication
(10) Pub. No.: US 2012/0236275 A1
(43) Pub. Date: Sep. 20, 2012

(54) PROJECTION SYSTEM, LITHOGRAPHIC APPARATUS AND DEVICE MANUFACTURING METHOD

(75) Inventors: Frank Johannes Jacobus VAN BOXTEL, Eindhoven (NL); Roelof Frederik De Graaf, Veldhoven (NL); Antonius Johannus Van Der Net, Tilburg (NL); Johannes Antonius Maria Martina Van Uijtregt, Eersel (NL); Leonarda Hendrika Van Den Heuvel, Aarle-Rixtel (NL)

(73) Assignee: ASML NETHERLANDS B.V., Veldhoven (NL)

(21) Appl. No.: 13/418,936

(22) Filed: Mar. 13, 2012

Related U.S. Application Data
(60) Provisional application No. 61/452,374, filed on Mar. 14, 2011.

(51) Int. Cl. G03B 27/52

(52) U.S. Cl. 355/30

(57) ABSTRACT

Various configurations of a projection system, of a lithographic apparatus, and of a device manufacturing method are disclosed. According to a disclosed configuration, the projection system is configured to project a patterned radiation beam onto a target portion of a substrate. The projection system includes an optical element having a first face and a second face. The first face is configured to be exposed to an external gaseous environment connected to the outside of the lithographic apparatus. The second face is configured to be exposed to an internal gaseous environment, the internal gaseous environment being substantially isolated from the external gaseous environment. The projection system further includes a pressure compensation system configured to adjust the pressure in the internal gaseous environment in response to a change in pressure in the external gaseous environment or a pressure differential between the internal gaseous environment or the external gaseous environment.

This application claims priority and benefit under 35 U.S.C. §119(e) to U.S. Provisional Patent Application No. 61/452,374, entitled “Projection System, Lithographic Apparatus and Device Manufacturing Method”, filed on Mar. 14, 2011. The content of that application is incorporated herein in its entirety by reference.

### FIELD

The present invention relates to a projection system, a lithographic apparatus and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

### SUMMARY

A projection system may be provided to direct patterned from the patterning device onto the substrate. A typical projection system will comprise a series of elements (e.g. optical elements such as lenses) assembled in a housing, also known as a lens barrel. The gaseous environment inside the lens barrel should be controlled carefully so that it does not interfere with the optical performance of the device, or damage sensitive optical elements. For example, dust should be excluded, levels of humidity should be kept substantially constant (typically very low), and/or levels of chemical contamination (organic and/or inorganic) should be tightly controlled. The composition of the gas should also be controlled. Control of the gaseous environment may include maintaining a flow of gas through the gaseous environment. The pressure is generally maintained at a level above atmospheric pressure to discourage inflow of gas and/or contaminants from outside the projection system.

Variation in the pressure difference between a gaseous environment inside the projection system and the environment outside the projection system can reduce the accuracy of the image formed on the substrate.

It is desirable, for example, to reduce the extent to which image accuracy is reduced by such variation.

According to an aspect, there is provided a projection system for a lithographic apparatus, wherein: the projection system is configured to project a patterned radiation beam onto a target portion of a substrate; the projection system comprises a first optical element, the first optical element comprising a first face and a second face; the first face is configured to be exposed to an external gaseous environment connected to the outside of the lithographic apparatus; the second face is configured to be exposed to an internal gaseous environment, the internal gaseous environment being substantially isolated from the external gaseous environment; and the projection system further comprises a pressure compensation system configured to adjust the pressure in the internal gaseous environment in response to a change in pressure in the external gaseous environment.

According to an aspect, there is provided a lithographic apparatus comprising: a projection system configured to project a patterned radiation beam onto a target portion of a substrate, the projection system comprising an optical element having a first face and a second face, wherein the first face is configured to be exposed to an external gaseous environment connected to the outside of the lithographic apparatus and the second face is configured to be exposed to an internal gaseous environment, the internal gaseous environment being substantially isolated from the external gaseous environment; and a pressure compensation system configured to adjust the pressure in the internal gaseous environment in response to a change in pressure in the external gaseous environment.

According to an aspect, there is provided a lithographic apparatus comprising: a projection system configured to project a patterned radiation beam onto a target portion of a substrate, the projection system comprising an optical element having a first face and a second face, wherein the first face is configured to be exposed to an external gaseous environment connected to the outside of the lithographic apparatus and the second face is configured to be exposed to an internal gaseous environment, the internal gaseous environment being substantially isolated from the external gaseous environment and there being, in use, a pressure differential between the internal gaseous environment and the external gaseous environment; and a pressure compensation system configured to adjust the pressure in the internal gaseous environment in response to a measured change in the pressure differential.

According to an aspect, there is provided a device manufacturing method, comprising: using a projection system to project a patterned radiation beam onto a substrate, wherein the projection system comprises an optical element having a first face and a second face, the first face exposed to an external gaseous environment connected to the outside of the projection system and the second face exposed to an internal gaseous environment, the internal gaseous environment being substantially isolated from the external gaseous environment; and adjusting the pressure in the internal gaseous environment in response to a change in pressure in the external gaseous environment.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts an internal gaseous environment at an upper or lower portion of a projection system, with a passive component comprising a piston and a cylinder;

FIG. 3 depicts a passive component comprising a membrane;

FIG. 4 depicts a passive component comprising a bellows;

FIG. 5 depicts an internal gaseous environment at an upper or lower portion of a projection system, with an active component comprising a piston, a cylinder, and a piston driver;

FIG. 6 depicts an active component comprising a membrane and a membrane driver;

FIG. 7 depicts an active component comprising a bellows and a bellows driver;

FIG. 8 depicts an internal gaseous environment at an upper or lower portion of a projection system, with a gas particle adjuster to adjust the number of gas particles (i.e. the amount of gas) in the internal gaseous environment, comprising high and low pressure reservoirs and associated valves;

FIG. 9 depicts a gas particle adjuster comprising a series of low pressure reservoirs of different volumes and a series of high pressure reservoirs held at different pressures;

FIG. 10 depicts a variation of the system shown in FIG. 8; and

FIG. 11 depicts a variation of the system shown in FIG. 9 in accordance with the system shown in FIG. 8.

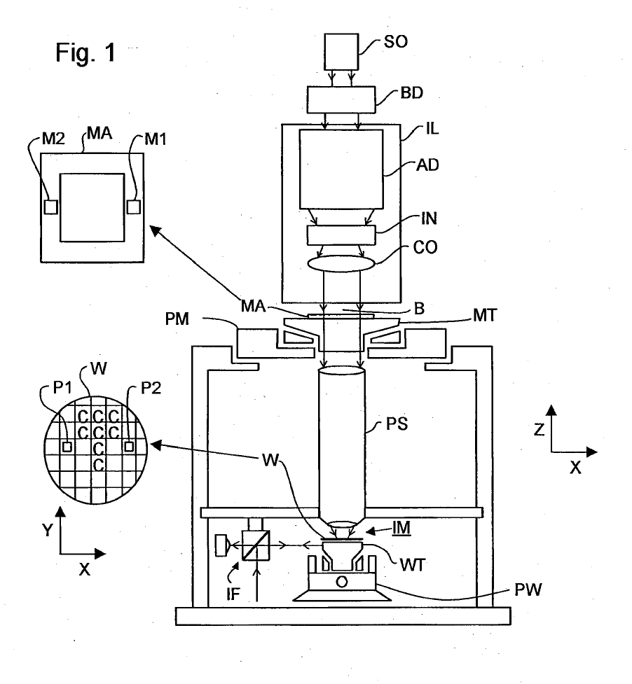

### DETAILED DESCRIPTION FIG. 1 schematically depicts a lithographic apparatus according to one embodiment of the invention. The apparatus comprises:

an illumination system (illuminator) IL configured to condition a radiation beam B (e.g. UV radiation or DUV radiation).

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated wafer) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, to direct, shape, or control radiation.

The support structure MT holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two or more tables (or stages or supports), e.g. two or more substrate tables or a combination of one or more substrate tables and one or more sensor or measurement tables. In such “multiple stage” machines the additional tables may be used in parallel, or preparatory steps may be carried out on one or more tables while one or more other tables are being used for exposure. The lithographic apparatus may have two or more patterning devices (or stages or supports) which may be used in parallel in a similar manner to substrate, sensor and measurement tables.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not exclusively mean that a structure, such as a substrate, must be submerged in liquid, but rather that liquid can be located between the projection system and the substrate and/or patterning device during exposure. This may or may not involve a structure, such as a substrate, being submerged in liquid. Reference sign IM shows where apparatus to implement an immersion technique may be located. Such apparatus may include a supply system for the immersion liquid and a liquid confinement structure to contain the liquid in the region of interest.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.
2. In scan mode, the support structure MT and the substrate table WT are scanned synchronously while a pattern imparted to the radiation beam is projected onto a target portion C (i.e. a single dynamic exposure). The velocity and direction of the substrate table WT relative to the support structure MT may be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
3. In another mode, the support structure MT is kept essentially stationary holding a programmable patterning device, and the substrate table WT is moved or scanned while a pattern imparted to the radiation beam is projected onto a target portion C. In this mode, as in other modes, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As mentioned above, variation in the pressure difference between an internal gaseous environment inside the lens barrel and the environment outside the projection system (e.g. the “clean room” and hereinafter generally the outside environment) can reduce the accuracy of the image formed on the substrate. The reduced optical accuracy can occur because of a resulting change in the pressure difference across an optical element (e.g. which could be an individual lens for example). The change in pressure difference across the optical element can lead to distortion and/or displacement of the optical element and a corresponding change in the optical performance of the projection system. The change in pressure difference may be much larger for an optical element at the extreme upper and/or lower ends of the projection system, which are exposed on one side to the pressure of the outside environment and on the other side to an internal gaseous environment that is substantially isolated from the outside environment. The pressure in the outside environment can vary significantly and over relatively short time scales. For example, the closing of a door in the outside environment may typically cause a pressure fluctuation of up to 25 Pa at the lithographic apparatus, although the exact size will depend on many factors, including the size of the outside environment, the nature and location of the door, the manner in which it was closed, etc. A continuous flow of gas through the internal gaseous environment may be provided. The continuous flow of gas may be useful for removing contaminants originating from outgassing, for example. The flow of gas may also assist with controlling heating in an optical element adjacent to the internal gaseous environment, although typically the flow will be too low in comparison with the volume of the internal gaseous environment for this to be very effective. The in-flow and/or out-flow of gas could in principle be adjusted to control the overall pressure. However, it is difficult for such a system to respond quickly enough to compensate effectively for pressure fluctuations originating in the outside environment.

In the following description, the term “external gaseous environment” is used to refer to any volume which is not substantially isolated from (otherwise referred to as sealed off from) the outside environment, and which is therefore maintained at substantially the same pressure (i.e. about atmospheric pressure) as the outside environment (e.g., the clean room). The external gaseous environment may thus be considered to be “connected to” the environment outside the lithographic apparatus. In this context, an external gaseous environment can thus exist inside the lithographic apparatus. In contrast, an “internal gaseous environment” refers to a volume which is substantially isolated from the outside environment. The term “substantially isolated” in this context means isolated to an extent that allows independent pressure regulation. The fact that the internal gaseous environment is substantially isolated from the external gaseous environment therefore means that the pressure in the internal gaseous environment will be substantially independent of the pressure in the external gaseous environment (in the absence of deliberate measures to adjust the pressure in the internal gaseous environment in response to changes in the pressure of the external gaseous environment). Therefore, the pressure in the internal gaseous environment may be maintained at a level that is substantially different to the pressure in the external gaseous environment. Generally, the pressure in the internal gaseous environment will be maintained at a level that is higher than the nominal pressure of the external gaseous environment, though this is not essential. The pressure of the internal gaseous environment may be held at a pressure that is substantially the same as the nominal pressure of the external gaseous environment, or at a lower level.

The internal gaseous environment may be located at an upper portion of the projection system. The internal gaseous environment in this case would be between a first optical element (i.e. the first optical element of the projection system that is encountered by the patterned radiation beam) and an adjacent optical element (the “second” optical element). However, an embodiment of the invention is also or alternatively applicable to the last element of the projection system (located at the lower end thereof). In this case, the “internal gaseous environment” would be the region between the last optical element and the penultimate optical element. In an immersion system, the last optical element would be the optical element which in use would be in contact with the immersion liquid located between the projection system and the substrate during exposure. An embodiment of the invention may also or alternatively be applied to another element of the projection system or other optical system (e.g., an illumination system).

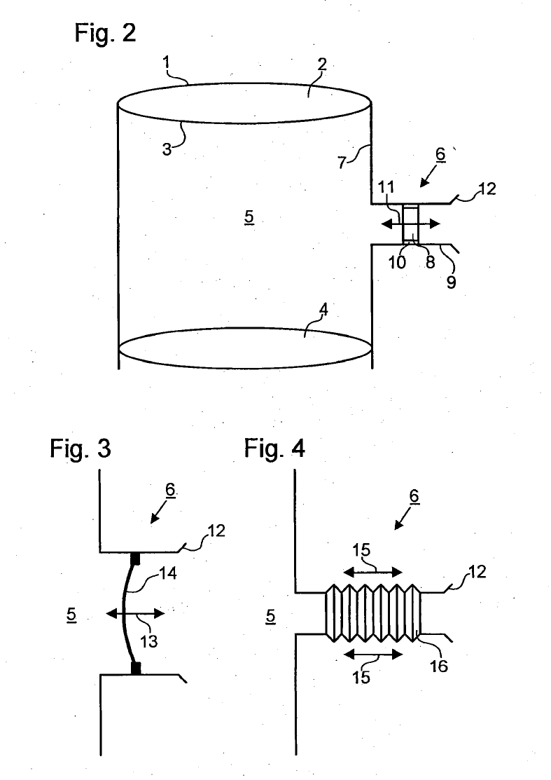

FIG. 2 may be considered to depict an upper or lower portion of the projection system. In the case where FIG. 2 is considered to represent an upper portion of the projection system, the upper part of FIG. 2 (i.e. element 2) is considered to be higher than the lower part of the FIG. 2 (i.e. element 4). In the case where FIG. 2 is considered to represent a lower portion of the projection system, the upper part of the FIG. 2 (i.e. element 2) is considered to be lower than the lower part of FIG. 2 (i.e. element 4). The portion depicted comprises an optical element 2 (the “first optical element” in the case where FIG. 2 is considered to illustrate an upper portion of the projection system, or the “final optical element” in the case where FIG. 2 is considered to illustrate a lower portion of the projection system) having a first face 1 exposed to an external gaseous environment and a second face 3 that is substantially isolated from the external gaseous environment and exposed instead to a controlled (actively and/or passively) internal gaseous environment 5. The optical element 2 is housed within a lens barrel 7 which will generally be sufficiently rigid not to be deformed significantly by variation in the pressure across it. The region between the optical element 2 and the adjacent optical element 4 defines the internal gaseous environment.

According to disclosed embodiments, a pressure compensation system is provided to adjust the pressure in the internal gaseous environment in response to a change in pressure in the external gaseous environment. The pressure compensation system reacts to changes in the pressure in the external gaseous environment in such a way as to reduce the resulting change in the pressure difference across the optical element 2.

In the embodiments shown in FIGS. 2 to 7, a volume adjuster 6 is provided to adjust the volume of the internal gaseous environment. The volume adjuster 6 is configured to decrease the volume of the internal gaseous environment in response to an increase in pressure of the external gaseous environment, to increase the volume of the internal gaseous environment in response to a decrease in pressure of the external gaseous environment, or both.

In FIGS. 2 to 4 the volume adjuster comprises a component that is configured to respond passively to a change in pressure of the external gaseous environment. The passive component responds without requiring an external power source or an active control system.

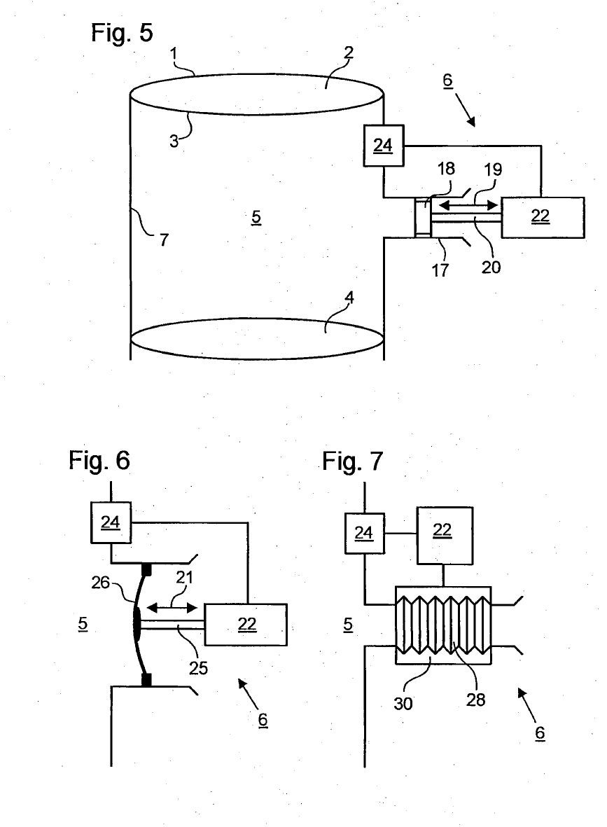

In FIGS. 5 to 7 the volume adjuster comprises a component that is configured to change the volume of the internal gaseous environment actively. The active component comprises a mechanism that relies on a power supply and a control system (controller).

In FIG. 2, the passive component comprises a piston 8 that is moveable (arrows 11) within a cylinder 9. The cross-sectional shape of the piston 8 corresponds with the internal cross-sectional shape of the cylinder 9 (which will may be circular, but other forms could also be used). A sliding seal 10 is provided between the piston 8 and cylinder 9 to prevent or minimize leakage of gas past the piston 8. The cylinder 9 may be connected at one end to the internal gaseous environment and at the other end to an opening 12. The opening 12 leads to a space that is connected to the external gaseous environment. The system is configured such that an increase in the pressure in the external gaseous environment causes the piston 8 to move inwards (to the left in the figure), thereby reducing the volume of the internal gaseous environment and causing a compensatory rise in the pressure therein. A decrease in the pressure in the external gaseous environment causes the piston 8 to be pushed outwards (to the right in the figure), thereby increasing the volume of the internal gaseous environment and causing a compensatory decrease in the pressure therein. In both cases, the effect is to decrease the size of variations in the pressure difference across the optical element 2 caused by pressure fluctuations in the external gaseous environment. Where the pressure in the internal gaseous environment is maintained at a higher level of pressure than the pressure in the external gaseous environment, the piston 8 will be provided with a resilient member (not shown) biasing the piston 8 towards the interior of the internal gaseous environment. The biasing force is necessary to balance the nominal pressure difference across the piston 8. Where the pressure in the internal gaseous environment is maintained at a lower level than the pressure in the external gaseous environment, the piston 8 will be provided with a resilient member (not shown) biasing the piston 8 towards the exterior of the internal gaseous environment.

The longitudinal axis of the piston 8 may be oriented downwards, sloping away from the internal gaseous environment. In this way, particulate contamination associated with the moving piston will tend to fall away from critical elements in the internal gaseous environment.

FIG. 3 depicts an embodiment in which the passive component comprises a deformable member 14 (a membrane, in this example) that is configured to deform inwards, outwards or inwards and outwards (arrows 13) in response to fluctuations in the pressure of the external gaseous environment. The operation of the arrangement of FIG. 3 corresponds to that of the operation of the piston 8 and cylinder 9 of the embodiment of FIG. 2. However, the change in volume of the internal gaseous environment 5 is achieved by deformation rather than by displacement. The arrangement of FIG. 3 is beneficial because moving parts are minimized. The risk of contamination of the internal gaseous environment 5 is thus reduced. The point of connection between the deformable member 14 and the lens barrel 5 is fixed, thereby facilitating provision of a reliable seal. A polytetrafluoroethylene (PTFE) membrane may be used as the deformable member, for example. A flow of dry purge gas may be provided in the region of the membrane to prevent influx of humidity through the membrane. In the case where the pressure in the internal gaseous environment 5 is to be maintained at a higher or a lower level than the pressure of the external gaseous environment, the deformable member 14 may again be provided with a resilient member (not shown) to provide the necessary biasing. For example, the deformable member 14 may be formed from a membrane having elastic properties.

FIG. 4 depicts an embodiment in which the passive component comprises a bellows 16 that is configured to change shape (arrows 15) in response to fluctuations in the pressure of the external gaseous environment. The operation of the bellows corresponds to that of the piston 8 and cylinder 9 arrangement, and deformable member 14 arrangement, both described above. The bellows 16 is configured to be driven inwards, outwards, or inwards and outwards (arrows 15) in response to fluctuations in the pressure of the external gaseous environment. The bellows 16 is, in effect, driven by the fluctuations in the pressure of the external gaseous environment to change the volume of the internal gaseous environment 5 in such a way as to at least partially compensate the fluctuation: an increase in the pressure in the external gaseous environment is accompanied by a corresponding decrease in the volume of the internal gaseous environment 5, and vice versa. As with the arrangement with the deformable element 14 of FIG. 3, the bellows 16 is beneficial because moving parts are minimized (there is no need for a sliding seal, for example). Particle formation is desirably minimized. If the pressure in the internal gaseous environment 5 is to be maintained at a higher or lower level than the pressure of the external gaseous environment, the bellows 16 may be provided with a resilient member to provide the necessary biasing, in a similar manner to the embodiments described above with reference to FIGS. 2 and 3.

FIGS. 5 to 7 depict embodiments that correspond respectively to the embodiments of FIGS. 2 to 4. The passive components of the embodiments of FIGS. 2 to 4 have been replaced by one or more active components which may correspond to those present in the arrangements shown in FIGS. 2 to 4. The system of each arrangement is provided with a pressure sensor system 24. The pressure sensor system 24 is configured to measure one or more of the following: the pressure in the external gaseous environment (via a pressure sensor in the external gaseous environment, for example), the pressure in the internal gaseous environment 5 (via a pressure sensor in the internal gaseous environment 5, for example), and/or the pressure differential between the internal gaseous environment 5 and the external gaseous environment (via a pressure differential sensor located at an interface between the internal gaseous environment and the external gaseous environment, for example). A controller 22 is provided which receives input from the pressure sensor system 24. The controller 22 may be configured to respond to the measured pressure in the external gaseous environment only. For example, the controller 22 may be configured to adjust the pressure in the internal gaseous volume by an amount corresponding to a detected change in the pressure in the external gaseous environment. Alternatively or additionally, the controller 22 may be configured to respond to the difference in pressure between the internal gaseous environment 5 and the external gaseous environment as derived from separate measurements of the pressure in the internal gaseous environment and the external gaseous environment (via separate sensors in each of the internal gaseous environment and the external gaseous environments). For example, the controller 22 may be configured to adjust the pressure in the internal gaseous volume by an amount corresponding to a detected change in the difference between the pressures in the internal and external gaseous environments. Alternatively or additionally, the controller 22 may be configured to respond to the pressure differential between the internal and external gaseous environments as derived from a direct measurement of the pressure differential via a pressure differential sensor. For example, the controller 22 may be configured to adjust the pressure in the internal gaseous volume by an amount corresponding to a detected change in the detected pressure differential.

In FIG. 5, a piston 18 and a cylinder 17 cooperate with a piston driver 20 that is configured to drive inward and outward movement (arrows 19) of the piston 18. The piston driver 20 drives the piston 18 in response to a control signal from the controller 22. The control signal is such as to cause the piston 18 to move in a direction that at least partially compensates a fluctuation in the pressure of the external gaseous environment (as measured by the pressure sensor system 24). For example, if the pressure in the external gaseous environment increases, the control signal will be such as to cause the piston driver 20 to drive the piston 18 inwards (to the left in the figure). If the pressure in the external gaseous environment decreases, the control signal will be such as to cause the piston 18 to move outwards (to the right in the figure). The controller 22 may be configured to operate in a feedback arrangement for example. The controller 22 may additionally or alternatively be configured to use feedforward control. The longitudinal axis of the piston 18 may be oriented downwards, sloping away from the internal gaseous environment 5. In this way, particulate contamination associated with the moving piston 18 will tend to fall away from critical elements in the internal gaseous environment 5.

In FIG. 6, a deformable member 26 cooperates with a deformable member driver 25. The deformable member driver 25 is configured to control the state of deformation (arrows 21) based on the control signal from the controller 22. For example, if the pressure in the external gaseous environment increases, the control signal will be such as to cause the deformable member driver 25 to cause the deformable member 26 to be deformed so as to decrease the volume of the internal gaseous environment 5. If the pressure of the external gaseous environment decreases, the control signal will be such as to cause the deformable member 26 to be deformed so as to increase the volume of the internal gaseous environment 5.

In FIG. 7, the bellows 28 is provided with a bellows driver 30 that is configured to control the volume of the bellows 28 based on the control signal from the controller 22. For example, if the pressure of the external gaseous environment increases, the control signal will be such as to cause the bellows driver 30 to cause the bellows 28 to decrease the volume of the internal gaseous environment. If the external gaseous pressure decreases, the control signal will be such as to cause the bellows 28 to increase the volume of the internal gaseous environment.

The embodiments of piston and cylinder, deformable member such as a membrane or bellows, or any subset thereof, of FIGS. 2 to 7 may be used in isolation, or together in any combination. In addition, although illustrated for the case where the internal gaseous environment 5 comprises substantially stationary gas, this need not be the case. For example, a purge gas supply system may be provided to supply a continuous flow of gas through the internal gaseous environment 5.

Additionally or alternatively, the pressure compensation system may comprise a gas particle adjuster to adjust the number of gas particles in the internal gaseous environment 5 (i.e. the amount of gas in the internal gaseous environment). The pressure in the internal gaseous environment 5 can be increased by increasing the number of gas particles. The pressure in the internal gaseous environment 5 can be decreased by decreasing the number of gas particles. This approach to manipulating the pressure in the internal gaseous environment 5 can be used on its own or in combination with any one or more of the above-described embodiments based on varying the volume of the internal gaseous environment 5.

The adjustment to the number of gas particles can be implemented by means of one or more reservoirs that are configured to contain gas at a pressure that is different from the pressure in the internal gaseous environment 5. Connecting such a reservoir to the internal gaseous environment will lead to a net flow of gas into or out of the internal gaseous environment 5. If the pressure in the reservoir is higher than the pressure in the internal gaseous environment 5, the net flow of gas will be into the internal gaseous environment 5. A net flow of gas into the internal gaseous environment 5 will tend to increase the pressure in the internal gaseous environment 5. If the pressure in the reservoir is lower than the pressure in the internal gaseous environment 5, the net flow of gas will be out of the internal gaseous environment 5. A net flow of gas out of the internal gaseous environment 5 will tend to decrease the pressure in the internal gaseous environment 5. Thus, by selectively controlling a connection to the reservoir that is at a different pressure to the internal gaseous environment 5, it is possible to control or adjust the flow of gas into or out of the internal gaseous environment 5.

The control or adjustment can be, for example, direct, via a direct connection between the reservoir and the internal gaseous environment 5. Alternatively or additionally, the control or adjustment can be indirect, via a connection to a supply line leading to or from the internal gaseous environment 5. The supply line may be a supply line associated with a purge gas supply system, for example, to supply a flow of purge gas through the internal gaseous environment 5. A reservoir that is configured to contain gas at a pressure that is below the pressure of the internal gaseous environment 5 may be referred to as a “low pressure reservoir”. A reservoir that is configured to contain gas at a pressure that is higher than the pressure of the internal gaseous environment 5 may be referred to as a “high pressure reservoir”. A reservoir that is one instance a low pressure reservoir may be in another instance a high pressure reservoir. A low pressure reservoir need not be distinct from a high pressure reservoir. For example, a reservoir may have a reduced pressure at one moment for the purpose of creating a net flow of gas out of the internal gaseous environment 5, and thus may be characterized as a low pressure reservoir. At another moment, the same reservoir may have high pressure for the purpose of creating a net flow of gas into the internal gaseous environment 5, and thus may be characterized as a high pressure reservoir. A reservoir can perform both low pressure and high pressure functions in, for example, a sequence, such as an alternating sequence.

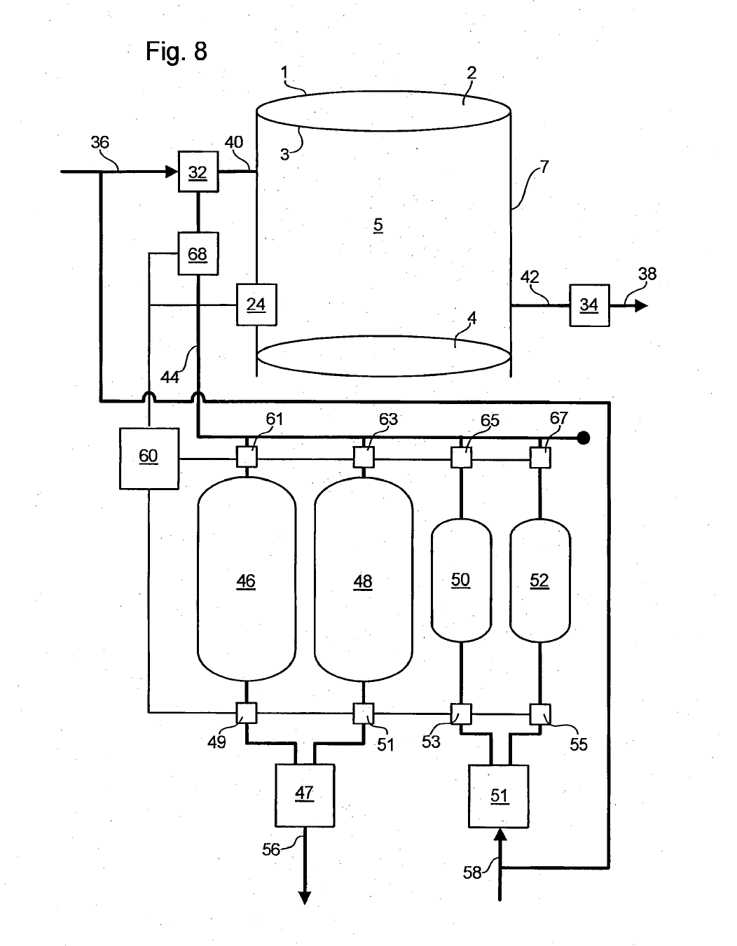

FIG. 8 depicts an example arrangement applied to an upper or lower portion of the projection system. The nature of the upper or lower portion of the projection system is described above with reference to FIG. 2. As in the embodiments described with reference to FIGS. 2 to 7, an optical element 2 is provided that has a first face 1 exposed to the external gaseous environment and a second face 3 exposed to an internal gaseous environment 5 housed in lens barrel 7. In this example, a purge gas supply system is provided to supply a flow of gas through the internal gaseous environment 5. The flow of gas can be used to remove outgassed contaminants from the internal gaseous environment 5, for example. The flow of gas may be continuous or sub-continuous (i.e. on for a period of time and off for a period of time, intermittently).

The purge gas supply system supplies gas from a source 36 via input gas controller 32 and input line 40 to the internal gaseous environment 5 and withdraws gas via output line 42 and output gas controller 34 to sink 38. The withdrawal can be active or passive.

In this example, the gas particle adjuster comprises two low pressure reservoirs 46 and 48, and two high pressure reservoirs 50 and 52. Each reservoir 46, 48, 50, 52 is connected via a valve 61, 63, 65, 67 to a supply line 44. The supply line 44 leads to the internal gaseous environment 5.

The low pressure reservoirs 46, 48 are maintained at a pressure that is lower than that of the internal gaseous environment 5, desirably at a pressure near vacuum, for example less than 0.1 bar absolute. In this way, opening of one or both valves 61, 63 leads to gas flowing out of the internal gaseous environment 5, or to redirection of the supplied flow, into one or both of the low pressure reservoirs 46, 48, The number of gas particles, and therefore the pressure, is thus decreased in the internal gaseous environment 5. An underpressure source 47 is provided to selectively decrease the pressure in the low pressure reservoirs 46, 48 via valves 49, 51 to gas sink 56.

The high pressure reservoirs 50, 52 are maintained at a pressure that is higher than that of the internal gaseous environment 5. In this way, opening of valve 65 or 67 will lead to gas flowing into the internal gaseous environment 5, thus increasing the number of gas particles, and therefore the pressure, in the internal gaseous environment 5. An overpressure source 51 is provided to selectively increase the pressure in the high pressure reservoirs 50, 52 via respective valves 53 and 55 from gas source 58. Gas source 58 may be derived from the source 36, as shown in the Figure, or from a separate source.

The rate of flow of gas from the low or high pressure reservoirs 46, 48, 50, 52 into or out of the internal gaseous environment 5 depends on the pressure difference between the reservoirs 46, 48, 50, 52 and the internal gaseous environment 5. The scope for increasing the pressure difference between the reservoirs 46, 48, 50, 52 and the internal gaseous environment 5 is limited with respect to the low pressure reservoirs 46, 48. This limitation arises because the pressure difference cannot exceed the pressure within the internal gaseous environment 5 (because the absolute pressure in the low pressure reservoirs 46, 48 cannot be made negative). However, this problem can be mitigated by making the low pressure reservoirs 46, 48 larger in volume, such that the rate at which the pressures in the reservoirs rise when they are connected to the internal gaseous environment 5 is lower. For the high pressure reservoirs, the pressure difference can be made much greater than for the low pressure reservoirs. The high pressure reservoirs can thus be made smaller. Making the high pressure reservoirs smaller is generally desirable because it is advantageous to locate the reservoirs as close as possible to the internal gaseous environment 5 and space in this region is limited.

A controller 60 is provided to control the opening of the valves 61, 63, 65, 67 in response to a reading of the pressure sensor system 24. If the external pressure increases, the controller 60 will open one or both of the valves 65, 67 leading to the high pressure reservoirs. Opening one or both of the valves 65, 67 leading to the high pressure reservoirs will increase the pressure in the internal gaseous environment 5. If the external pressure decreases, the controller 60 will open one or both of the valves 61, 63 leading to the low pressure reservoirs. Opening one or both of the valves 61, 63 leading to the low pressure reservoirs will decrease the pressure in the internal gaseous environment 5. The controller 60 in this example is also configured to control valves 49, 51, 53 and 55 to ensure that the pressures in the reservoirs are driven to the desired starting values ready for use.

In this example a plurality of low pressure reservoirs 46, 48 are provided. This provides the possibility of varying the rate at which gas is withdrawn (and/or the total amount of gas that is withdrawn) from the internal gaseous environment 5 by selectively opening one or both of the reservoirs 46, 48. Alternatively or additionally, the plurality of reservoirs allows the pressure to be decreased back towards a starting value in one reservoir while another reservoir is being used to adjust the pressure in the internal gaseous environment 5.

Similarly, the plurality of high pressure reservoirs 50, 52 provides the possibility of varying the rate at which gas is supplied (and/or the total amount of gas that is supplied) to the internal gaseous environment 5 by selectively opening one or both of the reservoirs 50, 52. Alternatively or additionally, the plurality of reservoirs allows the pressure to be increased back towards a starting value in one reservoir while another reservoir is being used to adjust the pressure in the internal gaseous environment 5. An alternative or additional method for adjusting the rate of flow of gas from a given reservoir 46, 48, 50, 52 is to provide one or more valves that are capable of providing a variable flow resistance between the reservoir 46, 48, 50, 52 and the supply line 44. For example, the valve could provide a continuously variable flow resistance from a fully closed state (very high flow resistance) to a fully open state (very low flow resistance). Alternatively or additionally, the valve could be configured to apply a selectable one of a plurality of discrete flow resistances greater than two. The controller 60 in either one of these variations would be configured, as a function of the desired rate of flow of gas, to: 1) select which reservoirs are to be opened; and/or 2) select the extent to which the valves to the selected reservoir(s) should be opened (i.e. select the flow resistance(s) of the valve(s)).

The controller 60 may generally be configured to control the rate of flow of gas as a function of the size of a detected difference between the measured pressure of the external gaseous environment and the expected or measured pressure within the internal gaseous environment. If a large fluctuation is detected, the controller 60 will open more reservoirs and/or open valves further than if a smaller fluctuation is detected. Optionally, a flow meter 68 is provided to measure the rate of flow of gas in the supply line 44. The reading from the flow meter 68 is fed to the controller 60. The controller 60 is configured to take the reading into account when calculating the control signal to be applied to one or more of the valves 61, 63, 65, 67. For example, the controller 60 may be configured to vary actuation of the valves until the flow rate measured by the flow meter 68 converges to a certain flow rate, e.g. a target set point flow rate. Alternatively or additionally, the controller 60 is configured to control the time for which the selected reservoir(s) 46, 48, 50, 52 is/are opened in order to control the amount by which the pressure of the internal gaseous environment 5 is adjusted.

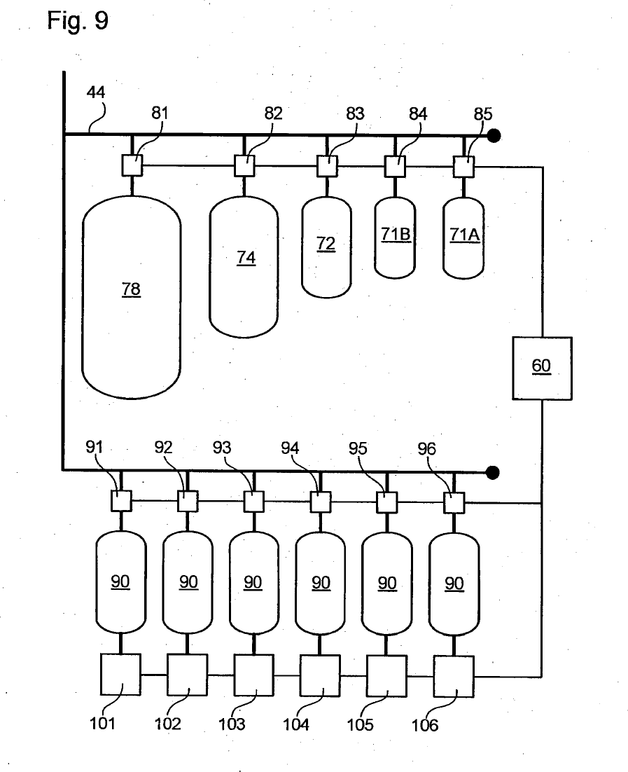

FIG. 9 illustrates a further configuration for the system of reservoirs connected to the supply line 44. Here, a plurality of low pressure reservoirs 71A, 71B, 72, 74 and 78 having relative volumes in the series 1:1:2:4:8 are provided. This series has a property that the volumes can be selectively summed to provide a range of total volumes that are evenly spaced (16 different total volumes, evenly spaced). It is possible to select the desired total volume by controlling which of the valves 81-85 are opened. Other series may be chosen depending on the range of effective volumes that are desired. The greater the number of possible volumes the greater the scope for adjusting the size and/or speed of the corrective outflow of gas from the internal gaseous environment 5. For example, the series 1:1:2:4:8:16 would allow twice the number of discrete steps in comparison with the series 1:1:2:4:8. A higher number of discrete steps may allow compensation to be achieved at a higher resolution. Alternatively or additionally, the low pressure reservoirs may be arranged to have different pressures.

The variation of FIG. 9 also comprises a series of high pressure reservoirs 90 configured so that the pressure in each can be individually controlled. In the example shown, the individual control is achieved by means of individually assigned overpressure supplies 101-106. Alternatively or additionally, a common overpressure supply may be used. In this case, each reservoir may be provided with an individual overpressure release valve that can be set at a desired pressure. The latter approach may be cheaper to implement because fewer overpressure sources are required.

The pressures in the reservoirs 101-106 may be adjusted to achieve a series such as that for the low pressure reservoirs 71A, 71B, 72, 74, 78. Such a series allows a range of suitable inflows to be selected according to which of the valves 91-96 are opened. For example, the pressures of the reservoirs 90 may be chosen to have ratios in the power series 1:1:2:4:8:16. The controller 60 may even be configured to vary the nominal pressures (i.e. the pressures before the reservoirs are opened) in use according to detected fluctuations or user requirements. Alternatively or additionally, the high pressure reservoirs may be arranged to have different volumes.

In the example shown in FIG. 9, the low pressure reservoirs are provided with different volumes and the high pressure reservoirs are provided with different pressures, but it will be understood that these features could be provided independently. The low pressure reservoirs could be provided with different volumes while the high pressure reservoirs are maintained at the same pressure (or only a single high pressure reservoir is provided). Similarly, the high pressure reservoirs may be provided with different pressures while the low pressure reservoirs all have the same volume (or only a single low pressure reservoir may be provided).

It is expected that overpressures up to about 6 bar absolute would be practical for the high pressure reservoirs. For the low pressure reservoirs, it is expected that pressures down to about 0.1 bar absolute would be practical. In many situations, it is expected that the volumes of the high pressure reservoirs could be in the range of between about 0.01 liter and 0.1 liter, for example. The most appropriate volume for each reservoir would depend on the type of pressure fluctuation that is expected, e.g. the expected size and duration. As explained above, the type of fluctuation will depend on the nature of the installation site, among other factors. For example, the size of the outside environment will be relevant. The size of individual reservoirs will also depend on how many reservoirs are provided and on whether multiple reservoirs can be used simultaneously for compensation purposes. The volume will also depend on the pressure that is maintained within the reservoir prior to actuation.

The following are illustrative examples for the case where a single reservoir is used to compensate a single fluctuation event. For a high pressure reservoir to compensate the 25 Pa pressure fluctuation mentioned earlier, a volume of about 0.05 liters could be used if the reservoir is maintained at 2 bar absolute. A volume of about 0.01 liters could be used if the reservoir is maintained at 6 bar absolute. For a low pressure reservoir to compensate a 25 Pa overpressure fluctuation, a volume of about 0.05 liters could be used if the reservoir is maintained at about 0.1 bar absolute.

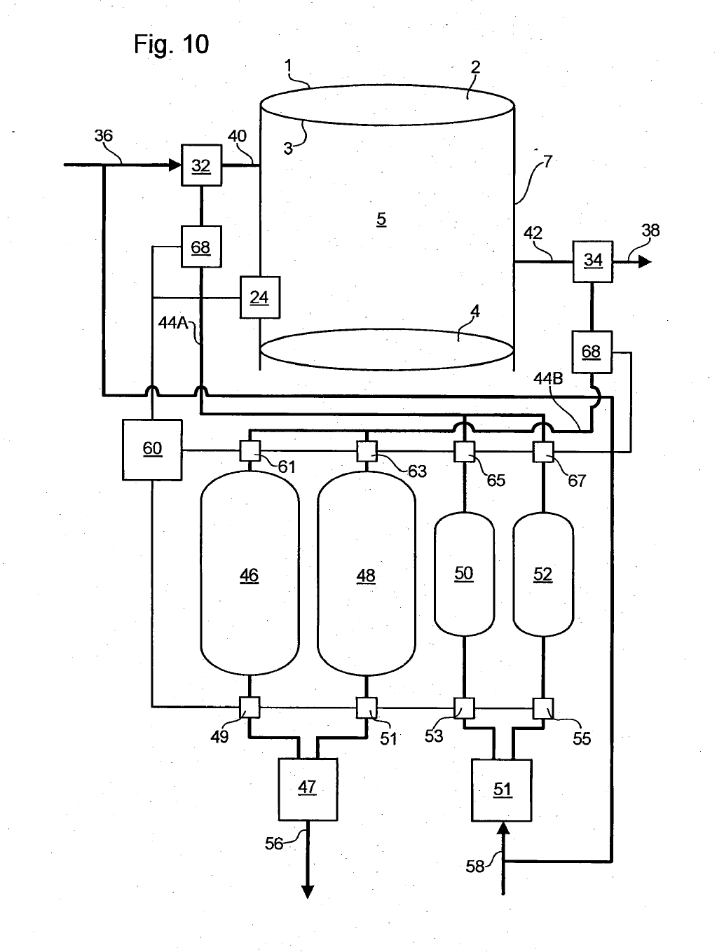

FIG. 10 depicts a variation of the arrangement of FIG. 8. Here, the low pressure reservoirs 46 and 48 are connected (via optional flow meter 68) to supply line 44B rather than to supply line 44 (as in FIG. 8). Supply line 44B leads to the output side of the purge gas supply system, namely, the output gas controller 34 and/or output line 42 in this example. In effect, the low pressure reservoirs 46 and 48 are configured to be able (i.e. the necessary connections are provided) to cause withdrawal of gas via the output line 42. The high pressure reservoirs 50 and 52 are connected (via optional flow meter 68) to supply line 44A. Supply line 44A is similar to supply line 44 of FIG. 8. Supply line 44A leads to the input side of the purge gas supply system, namely, the input gas controller 32 and/or input line 40 in this example. In effect, the high pressure reservoirs 50 and 52 are configured to be able (i.e. the necessary connections are provided) to supply gas to the internal gaseous environment via the input line 40. The functionality of FIG. 10 is the same as the functionality described above with reference to FIG. 8, except that the connection of the low pressure reservoirs to the output side helps ensure that their use to adjust the pressure in the internal gaseous environment 5 does not result in an undesirable change in direction of the purge gas flow through the internal gaseous environment 5. Additionally, relative to the configuration of FIG. 8, the arrangement of FIG. 10 will tend to increase the flow of purge gas through the internal gaseous environment 5. The increased flow of purge gas may improve the intended action of the purge gas. For example, the increased flow may improve the efficiency with which outgassed contaminants are removed from the internal gaseous environment 5.

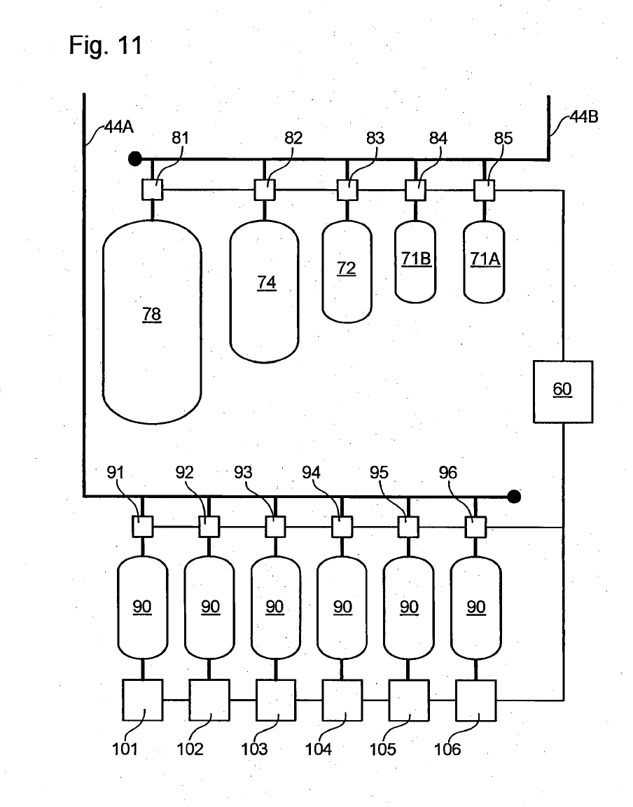

FIG. 11 depicts a configuration for the system of reservoirs connected to the supply lines 44A and 44B of FIG. 10. The arrangement of reservoirs is the same as that described above with reference to FIG. 9 except that the low pressure reservoirs 71A, 71B, 72, 74, 78 are connected to the output side supply line 44B, and the high pressure reservoirs 90 are connected to the input side supply line 44A. Desirable effects of this arrangement include those discussed above with reference to FIG. 10. Undesirable changes in direction of the purge gas flow are avoided. In addition, the average rate of flow of purge gas will tend to be increased, which may improve the function of the purge gas. For example, the removal of outgassed contaminants may be improved.

In an embodiment, there is provided a projection system for a lithographic apparatus, wherein: the projection system is configured to project a patterned radiation beam onto a target portion of a substrate; the projection system comprises an optical element, the optical element comprising a first face and a second face; the first face is configured to be exposed to an external gaseous environment connected to the outside of the lithographic apparatus; the second face is configured to be exposed to an internal gaseous environment, the internal gaseous environment being substantially isolated from the external gaseous environment; and the projection system further comprises a pressure compensation system configured to adjust the pressure in the internal gaseous environment in response to a change in pressure in the external gaseous environment.

In an embodiment, the pressure compensation system comprises a volume adjuster to adjust the volume of the internal gaseous environment. In an embodiment, the pressure compensation system is configured to: decrease the volume of the internal gaseous environment in response to an increase in pressure of the external gaseous environment; and increase the volume of the internal gaseous environment in response to a decrease in pressure of the external gaseous environment. In an embodiment, the projection system comprises one or more selected from the following to adjust the volume of the internal gaseous environment: a piston and cylinder, a piston and cylinder having a longitudinal axis that slopes away from the internal gaseous volume, a bellows, and/or a deformable membrane. In an embodiment, the pressure compensation system comprises: a pressure sensor system configured to measure one or more selected from the following: the pressure in the external gaseous environment, the pressure in the internal gaseous environment, and/or the pressure differential between the internal gaseous environment and the external gaseous environment; and a controller configured to control the pressure compensation system based on an output from the pressure sensor system. In an embodiment, the pressure compensation system comprises a component that is configured to adjust the volume of the internal gaseous environment in response to a control signal from the controller. In an embodiment, the component that is configured to adjust the volume of the internal gaseous environment in response to a control signal from the controller comprises one or more selected from the following: a piston and cylinder, a piston and cylinder having a longitudinal axis that slopes away from the internal gaseous environment, a bellows, and/or a deformable membrane. In an embodiment, the pressure compensation system comprises a component that is configured to adjust the volume of the internal gaseous environment passively. In an embodiment, the component that is configured to adjust the volume of the internal gaseous environment passively comprises one or more selected from the following: a piston and cylinder, a piston and cylinder having a longitudinal axis that slopes away from the internal gaseous environment, a bellows, and/or a deformable membrane. In an embodiment, the pressure compensation system comprises a gas particle adjuster to adjust the number of gas particles in the internal gaseous environment. In an embodiment, the pressure compensation system is configured to: increase the number of gas particles in the internal gaseous environment in response to an increase in pressure in the external gaseous environment; and decrease the number of gas particles in the internal gaseous environment in response to a decrease in pressure in the external gaseous environment. In an embodiment, the pressure compensation system comprises a reservoir to contain gas at a pressure different from the pressure in the internal gaseous environment; and the pressure compensation system is configured to control a connection to the reservoir in order to control or adjust a supply of gas to or from the internal gaseous environment. In an embodiment, the pressure compensation system is configured to adjust the flow resistance of the connection to the reservoir to a selectable one of a plurality of discrete values greater than 2, to a continuous range of values, or both. In an embodiment, the pressure compensation system comprises a plurality of the reservoirs configured to contain gas at a higher pressure than the pressure of the internal gaseous environment, a plurality of the reservoirs configured to contain gas at a lower pressure than the pressure of the internal gaseous environment, or both; and the pressure compensation system is configured to control a connection to each of the reservoirs in order to control or adjust a supply of gas to the internal gaseous environment. In an embodiment, all or a subset of the plurality of reservoirs configured to contain gas at a higher pressure than the pressure of the internal gaseous environment, all or a subset of the plurality of reservoirs configured to contain gas at a lower pressure than the pressure of the internal gaseous environment, or both, are held at different pressures, have different volumes, or both. In an embodiment, the different pressures, the different volumes, or both, comprise a series of values that can be selectively summed to provide a range of evenly spaced totals. In an embodiment, the pressure compensation system is configured to control the amount of adjustment to the pressure in the internal gaseous environment by selectively opening all or a subset of the connections to the reservoirs. In an embodiment, the pressure compensation system is configured to control the amount of adjustment to the pressure in the internal gaseous environment by selectively varying the flow resistance associated with each, or each of a selected subset of, the connections to the plurality of reservoirs. In an embodiment, the projection system further comprises a flow meter to measure the flow rate of gas into or out of the internal gaseous environment, the pressure compensation system being configured to use an output from the flow meter to adjust the pressure in the internal gaseous environment. In an embodiment, the internal gaseous environment is maintained at a pressure different from the pressure of the external gaseous environment. In an embodiment, the projection system further comprises a purge gas supply system configured to provide a continuous flow of gas through the internal gaseous environment. In an embodiment, the purge gas supply system is configured to supply gas to the internal gaseous environment via an input line and withdraw gas from the internal gaseous environment via an output line; the pressure compensation system comprises one or more reservoirs to contain gas at a pressure that is higher than the pressure in the internal gaseous environment, and one or more reservoirs to contain gas at a pressure that is lower than the pressure in the internal gaseous environment; the one or more reservoirs to contain gas at a pressure that is higher than the pressure in the internal gaseous environment are configured to be able to supply gas to the internal gaseous environment via the input line; and the one or more reservoirs to contain gas at a pressure that is lower than the pressure in the internal gaseous environment are configured to be able to withdraw gas from the internal gaseous environment via the output line.

In an embodiment, there is provided a lithographic apparatus comprising a projection system as described herein.

In an embodiment, there is provided a lithographic apparatus comprising: a projection system configured to project a patterned radiation beam onto a target portion of a substrate, the projection system comprising an optical element having a first face and a second face, wherein the first face is configured to be exposed to an external gaseous environment connected to the outside of the lithographic apparatus and the second face is configured to be exposed to an internal gaseous environment, the internal gaseous environment being substantially isolated from the external gaseous environment; and a pressure compensation system configured to adjust the pressure in the internal gaseous environment in response to a change in pressure in the external gaseous environment.

In an embodiment, there is provided a lithographic apparatus comprising: a projection system configured to project a patterned radiation beam onto a target portion of a substrate, the projection system comprising an optical element having a first face and a second face, wherein the first face is configured to be exposed to an external gaseous environment connected to the outside of the lithographic apparatus and the second face is configured to be exposed to an internal gaseous environment, the internal gaseous environment being substantially isolated from the external gaseous environment and there being, in use, a pressure differential between the internal gaseous environment and the external gaseous environment; and a pressure compensation system configured to adjust the pressure in the internal gaseous environment in response to a measured change in the pressure differential.

In an embodiment, there is provided a device manufacturing method, comprising: using a projection system to project a patterned radiation beam onto a substrate, wherein the projection system comprises an optical element having a first face and a second face, the first face exposed to an external gaseous environment connected to the outside of the projection system and the second face exposed to an internal gaseous environment, the internal gaseous environment being substantially isolated from the external gaseous environment; and adjusting the pressure in the internal gaseous environment in response to a change in pressure in the external gaseous environment.

In an embodiment, there is provided a projection system for a lithographic apparatus, wherein: the projection system is configured to project a patterned radiation beam onto a target portion of a substrate; the projection system comprises an optical element having a first face and a second face, the first face configured to be exposed to a first gaseous environment and the second face configured to be exposed to a second gaseous environment, the second gaseous environment being substantially isolated from the first gaseous environment; and the projection system further comprises a pressure compensation system configured to adjust the pressure in the second gaseous environment in response to a change in pressure in the first gaseous environment or a change in a pressure differential between the first and second gaseous environments.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 436, 405, 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A projection system for a lithographic apparatus, wherein:
the projection system is configured to project a patterned radiation beam onto a target portion of a substrate;
the projection system comprises an optical element, the optical element comprising a first face and a second face;
the first face is configured to be exposed to an external gaseous environment connected to the outside of the lithographic apparatus;
the second face is configured to be exposed to an internal gaseous environment, the internal gaseous environment being substantially isolated from the external gaseous environment; and
the projection system further comprises a pressure compensation system configured to adjust the pressure in the internal gaseous environment in response to a change in pressure in the external gaseous environment.

2. The projection system according to claim 1, wherein the pressure compensation system comprises a volume adjuster to adjust the volume of the internal gaseous environment.

3. The projection system according to claim 1, wherein the pressure compensation system is configured to:
decrease the volume of the internal gaseous environment in response to an increase in pressure of the external gaseous environment; and
increase the volume of the internal gaseous environment in response to a decrease in pressure of the external gaseous environment.

4. The projection system according claim 1, wherein the projection system comprises one or more selected from the following to adjust the volume of the internal gaseous environment: a piston and cylinder, a piston and cylinder having a longitudinal axis that slopes away from the internal gaseous volume, a bellows, and/or a deformable membrane.

5. The projection system according to claim 1, wherein the pressure compensation system comprises:
a pressure sensor system configured to measure one or more selected from the following: the pressure in the external gaseous environment, the pressure in the internal gaseous environment, and/or the pressure differential between the internal gaseous environment and the external gaseous environment; and
a controller configured to control the pressure compensation system based on an output from the pressure sensor system.

6. The projection system according to claim 5, wherein the pressure compensation system comprises a component that is configured to adjust the volume of the internal gaseous environment in response to a control signal from the controller.

7. The projection system according to claim 6, wherein the component that is configured to adjust the volume of the internal gaseous environment in response to a control signal from the controller comprises one or more selected from the following: a piston and cylinder, a piston and cylinder having a longitudinal axis that slopes away from the internal gaseous environment, a bellows, and/or a deformable membrane.

8. The projection system according to claim 1, wherein the pressure compensation system comprises a component that is configured to adjust the volume of the internal gaseous environment passively.

9. The projection system according to claim 8, wherein the component that is configured to adjust the volume of the internal gaseous environment passively comprises one or more selected from the following: a piston and cylinder, a piston and cylinder having a longitudinal axis that slopes away from the internal gaseous environment, a bellows, and/or a deformable membrane.

10. The projection system according claim 1, wherein the pressure compensation system comprises a gas particle adjuster to adjust the number of gas particles in the internal gaseous environment.

11. The projection system according to claim 1, wherein the pressure compensation system is configured to:
increase the number of gas particles in the internal gaseous environment in response to an increase in pressure in the external gaseous environment; and
decrease the number of gas particles in the internal gaseous environment in response to a decrease in pressure in the external gaseous environment.

12. The projection system according to claim 1, wherein
the pressure compensation system comprises a reservoir to contain gas at a pressure different from the pressure in the internal gaseous environment; and
the pressure compensation system is configured to control a connection to the reservoir in order to control or adjust a supply of gas to or from the internal gaseous environment.

13. The projection system according to claim 12, wherein:
the pressure compensation system comprises a plurality of the reservoirs configured to contain gas at a higher pressure than the pressure of the internal gaseous environment, a plurality of the reservoirs configured to contain gas at a lower pressure than the pressure of the internal gaseous environment, or both; and
the pressure compensation system is configured to control a connection to each of the reservoirs in order to control or adjust a supply of gas to the internal gaseous environment.

14. The projection system according to claim 1, further comprising a flow meter to measure the flow rate of gas into or out of the internal gaseous environment, the pressure compensation system being configured to use an output from the flow meter to adjust the pressure in the internal gaseous environment.

15. The projection system according to claim 1, wherein the internal gaseous environment is maintained at a pressure different from the pressure of the external gaseous environment.

16. The projection system according to claim 1, further comprising a purge gas supply system configured to provide a continuous flow of gas through the internal gaseous environment.

17. A lithographic apparatus comprising:
a projection system configured to project a patterned radiation beam onto a target portion of a substrate, the projection system comprising an optical element having a first face and a second face, wherein the first face is configured to be exposed to an external gaseous environment connected to the outside of the lithographic apparatus and the second face is configured to be exposed to an internal gaseous environment, the internal gaseous environment being substantially isolated from the external gaseous environment; and
a pressure compensation system configured to adjust the pressure in the internal gaseous environment in response to a change in pressure in the external gaseous environment.

18. A lithographic apparatus comprising:
a projection system configured to project a patterned radiation beam onto a target portion of a substrate, the projection system comprising an optical element having a first face and a second face, wherein the first face is configured to be exposed to an external gaseous environment connected to the outside of the lithographic apparatus and the second face is configured to be exposed to an internal gaseous environment, the internal gaseous environment being substantially isolated from the external gaseous environment and there being, in use, a pressure differential between the internal gaseous environment and the external gaseous environment; and
a pressure compensation system configured to adjust the pressure in the internal gaseous environment in response to a measured change in the pressure differential.

19. A device manufacturing method, comprising:
using a projection system to project a patterned radiation beam onto a substrate, wherein the projection system comprises an optical element having a first face and a second face, the first face exposed to an external gaseous environment connected to the outside of the projection system and the second face exposed to an internal gaseous environment, the internal gaseous environment being substantially isolated from the external gaseous environment; and
adjusting the pressure in the internal gaseous environment in response to a change in pressure in the external gaseous environment.

20. A projection system for a lithographic apparatus, wherein:
the projection system is configured to project a patterned radiation beam onto a target portion of a substrate;
the projection system comprises an optical element having a first face and a second face, the first face configured to be exposed to a first gaseous environment and the second face configured to be exposed to a second gaseous environment, the second gaseous environment being substantially isolated from the first gaseous environment; and
the projection system further comprises a pressure compensation system configured to adjust the pressure in the second gaseous environment in response to a change in pressure in the first gaseous environment or a change in a pressure differential between the first and second gaseous environments.
